(19) United States
(12) Patent Application Publication
(10) Pub. No.: US 2008/0211284 A1
(43) Pub. Date: Sep. 4, 2008

(54) Seat for vehicle

(75) Inventors: Hirofumi Mutou, Kariya-shi (JP); Takafumi Sekino, Miyoshi-cho (JP); Yukinori Sugiura, Nissin-shi (JP)

Correspondence Address: POSZ LAW GROUP, PLC, 12040 SOUTH LAKES DRIVE, SUITE 101, RESTON, VA, 20191, US

(73) Assignees: TOYOTA SHATAI KABUSHIKI KAISHA, Kariya-shi (JP); TOYOTA BOSHOKU KABUSHIKI KAISHA, Kariya-shi (JP)

(21) Appl. No.: 12/073,164

(22) Filed: Feb. 29, 2008

(30) Foreign Application Priority Data
Mar. 2, 2007 (JP) 2007-052273

(51) Int. Cl. B60N 2/04

(52) U.S. Cl. 297/354.1

(57) ABSTRACT

A seat for use in a vehicle, which is capable of being turned toward a door opening with a child seat, etc. attached thereto, thereby favorably sitting a child, etc. on the child seat, etc. A turning seat S2 is provided adjacently to a door opening K2 in a vehicle compartment and has a locking mechanism for locking a seat main body in a front-facing position or a rear-facing position. When a seat back 12 is tilted forward, the locking mechanism is released to enable turn of the seat main body. The turning seat S2 is arranged such that when lock of the seat main body is released with the seat back 12 held upright, and the seat main body is turned toward the door opening K2, turn stopping means operates to stop turn of the seat main body in a predetermined turning position in which the seat main body faces toward the door opening K2, and that the stopping operation with the turn stopping means is released when the seat back 12 is tilted forward.

### CROSS-REFERENCE TO RELATED APPLICATION

This application is related to and claims priority from Japanese Patent Application No. 2007-052273, incorporated herein by reference.

### BACKGROUND OF THE INVENTION

1. Field of the Invention

The present invention relates to a seat for a vehicle, and more particularly to a turning seat which is used as a second row seat of a vehicle such as a wagon-type vehicle, and to which a child seat, etc. are to be attached.

2. Description of Related Art

As shown in FIG. 1, in a wagon-type vehicle having sliding doors D1 and D2 on left and right sides of a vehicle body, separate seats S1 and S2 as second row seats are mounted in a vehicle compartment adjacently to left and right door openings K1 and K2. And turning seats are used as the second row seats of this type.

The turning seat has a seat main body which is supported with a turning device so as to turn to a front-facing position and a rear-facing position facing a third row seat. The seat main body includes a seat cushion and a seat back which can be reclined.

Where the second row seats S1 and S2 composed of the turning seats are turned, there occurs the problem that seat backs thereof contact side walls, etc. in the vehicle compartment to block smooth turning of the second row seats S1 and S2. To solve this problem, conventionally, a locking mechanism for the turning device has been released by tilting the seat back forward.

In the wagon-type vehicle having slide doors on both sides of a vehicle body, a child seat CS is normally attached to the second row seat S1 or S2. And a child can be sat on the child seat CS from the left door opening K1 or the right door opening K2 while being held in arms of parents, etc. The child seat CS has support portions which protrude upward on left and right sides thereof to obstruct smooth sitting of the child on the child seat CS from the left or right side thereof. If the second row seat S1 or S2 can be turned toward the door opening K1 or K2 with the child seat CS attached thereto, the child can be smoothly sat thereon. However, in the conventional second row seat, the seat back cannot be tilted forward with the child seat CS attached thereto so that there occurs the problem that the second row seat S1 or S2 cannot be turned toward the door opening K1 or K2.

Examples of the conventional turning seats for vehicle are disclosed in Publication of examined Japanese utility model application No. Hei 6-19400 and Publication of unexamined Japanese patent application No. Hei 8-67181. These publications propose the arrangement of turning a bench seat-type second row seat in a wagon-type vehicle to enable a passenger to easily get into or out of the vehicle, thereby achieving so-called “walk-through operation”. FIG. 2 shows one example of such an arrangement. As shown, a bench seat-type second row seat S4 and a third row seat S5 are mounted in a wagon-type vehicle which has a door opening K3 on one side of a vehicle body. When the passenger gets into the vehicle and sits on the third-row seat S5, or gets out of the vehicle after leaving the third-row seat S5, he releases lock of the second row seat S4 by tilting its seat back forward, and turns the second row seat S4 in the direction opposite to the door opening K3. With this arrangement, the above-described “walk-through operation” is achieved, but when a child seat is attached to the second row seat S4, a child cannot be easily sat on the child seat which does not face toward the door opening K3.

### SUMMARY OF THE INVENTION

The present invention has been made to provide a turning seat mounted adjacently to a door opening, such as a second row seat of a wagon-type vehicle, etc., which is capable of turning toward the door opening without tilting its seat back forward, and easily sitting a child on a child seat, etc. attached thereto.

The seat of the present invention is provided in a vehicle compartment adjacently to a door opening, and includes a seat main body having a seat cushion and a seat back capable of being reclined with a reclining lever of a reclining mechanism. The seat main body is mounted on a turning device so as to turn to a front-facing position and a rear-facing position. There are further provided a locking mechanism for locking the seat main body in the front-facing position and the rear-facing position such that lock of the seat main body is released with a lock releasing lever, and turn stopping means for stopping turn of the seat main body in a predetermined turning position in which the seat main body faces toward the door opening when lock of the seat main body is released by the lock releasing lever with the seat back held upright, and the seat main body is turned toward the door opening. The turn stopping means has such an arrangement that when the seat back is tilted forward by operating the reclining lever, stopping of turn of the seat main body is released to enable turn of the seat main body to the front-facing position and the rear-facing position.

With this arrangement, lock of the seat main body is released by the lock releasing lever with the seat back held upright. Consequently, the seat can be turned with a child seat attached thereto. Turn of the seat is stopped with the turn stopping means in the predetermined turning position in which the seat main body faces toward the door opening so that a child can be easily sat on the child seat. When the child seat is not attached to the seat of the present invention, by operating the reclining lever, the seat back is tilted forward to release stopping of turn of the seat, and by operating the lock releasing lever, lock of the seat is released to enable turn of the seat to the front-facing position and the rear-facing position.

It is preferable that the predetermined turning position of the seat main body is the position in which the seat main body is directed obliquely frontward so as to face the door opening.

In a preferred embodiment, the turning device includes a lower member provided along a floor of a vehicle compartment and an upper member provided to turn along the lower member for mounting the seat main body thereon. The locking mechanism includes an engaging portion which is provided in one of the lower member and the upper member, and a lock lever which is turnably supported with the other one of the lower member and the upper member in such a manner as to engage with and disengage from the engaging portion. The lock lever is connected to the lock releasing lever via first connecting means so as to be operated with the lock releasing lever. And the turn stopping means includes a stopper projection which is provided in one of the lower member and the upper member of the turning device, a stopper plate which is provided in the other one of the lower member and the upper member to contact the stopper projection when the seat main body turns toward the door opening and reaches the predetermined turning position, and a control plate which is provided in the other one of the lower member and the upper member near the stopper plate, and is connected to the reclining mechanism via second connecting means. The turn stopping means is arranged such that when the seat back is held upright, the control plate engages with the stopper plate to hold the stopper plate in contact with the stopper projection, thereby stopping turn of the seat main body, and that when the seat back is tilted forward, the control plate disengages from the stopper plate to make the stopper plate free from the stopper projection, thereby enabling turn of the seat main body to the front-facing position and the rear-facing position.

With this arrangement, by operating the lock releasing lever, the lock lever is released so that the seat can be turned with the child seat attached thereto (with the seat back held upright). In this case, when the seat turns, the stopper projection contacts the stopper plate, and the stopper plate is held with the control plate in the stopping position in which the stopper plate contacts the stopper projection, turn of the seat can be stopped in a predetermined turning position facing toward the door opening. Where the child seat is not attached to the seat, by tilting the seat back forward with the reclining lever, holding of the stopper plate with the control plate is released. Then, by operating the lock releasing lever to release the lock lever, and turning the seat, the stopper plate is pushed with the stopper projection, and consequently, the seat can be turned to the front-facing position and the rear-facing position.

In another preferred embodiment, the turning device includes a lower member provided along a floor of a vehicle compartment and an upper member provided to turn along the lower member for mounting the seat main body thereon. The locking mechanism includes an engaging portion which is provided in one of the lower member and the upper member, and a lock lever which is turnably supported with the other one of the lower member and the upper member in such a manner as to engage with and disengage from the engaging portion. The lock lever is connected to the lock releasing lever via first connecting means so as to be operated with the lock releasing lever. The turn stopping means includes a stopper projection which is provided in one of the lower member and the upper member of the turning device, and a stopper plate which is provided in the other one of the lower member and the upper member. A center of the stopper plate is turnably supported with the other one of the lower member and the upper member, and one end of the stopper plate is connected to the reclining mechanism via second connecting means. The turn stopping means is arranged such that when the seat main body of which the seat back is held upright is turned toward the door opening, and reaches the predetermined turning position, the other end of the stopper plate contacts the stopper projection to stop turn of the seat main body, and that when the seat back is tilted forward, the stopper plate moves in such a direction that the other end of the stopper plate separates from the stopper projection, thereby enabling turn of the seat main body to the front-facing position and the rear-facing position.

With this arrangement, by operating the lock releasing lever, the lock lever is released so that the seat can be turned with the child seat attached thereto (with the seat back held upright). In this case, when the stopper projection contacts the stopper plate, turn of the seat is stopped in a predetermined turning position facing toward the door opening. Where the child seat is not attached to the seat, by tilting the seat back forward with the operation of the reclining lever, holding of the stopper plate with the control plate is released. Then, by operating the lock releasing lever to release the lock lever, the seat can be turned to the front-facing position and the rear-facing position.

It is preferable to provide the lock releasing lever in one of a side surface and a front surface of the seat cushion of the seat which is in the front-facing position. With this arrangement, when the child seat is attached to the seat, the seat can be easily turned by operating the lock releasing lever from the exterior of the vehicle body via the door opening.

In accordance with the present invention, the turning seat such as a second row seat in a wagon-type vehicle, which is provided adjacently to the door opening, is turned to a predetermined turning position facing toward the door opening with the operation of a lock releasing lever even when the seat back is held upright. Where a child seat, etc. are attached to the thus arranged turning seat, by turning the turning seat toward the door opening, a child can be easily sat on the child seat, etc. And where the child seat, etc. are not attached to the thus arranged turning seat, by tilting the seat back forward and operating the lock releasing lever, the turning seat can be turned to the front-facing direction and the rear-facing direction.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a schematic diagram which shows a vehicle compartment of a wagon-type vehicle, which is provided with a seat for a vehicle in accordance with the present invention as a second row seat;

FIG. 2 is a schematic diagram which shows a vehicle compartment of a wagon-type vehicle, which is provided with a conventional bench seat achieving the walk-through operation;

FIG. 3(a) is a schematic perspective view of one embodiment of a seat for a vehicle in accordance with the present invention, to which a child seat is attached and which is in a front-facing position;

FIG. 3(b) is a schematic perspective view of one embodiment of a seat for a vehicle in accordance with the present invention, to which a child seat is attached and which is in the position turned toward a door opening;

FIG. 4 is a schematic diagram of one embodiment of a seat for a vehicle in accordance with the present invention, which is in the front-facing position;

FIG. 5 is a sectional view of a locking mechanism provided in one embodiment of a seat in accordance with the present invention, taken along line V-V in FIG. 4;

FIG. 6 is a schematic diagram of one embodiment of a seat for a vehicle in accordance with the present invention, which is turned toward a door opening;

FIG. 7 is a schematic plan view of turn stopping means provided in one embodiment of a seat in accordance with the present invention, which is in the state where turn of the seat is stopped;

FIG. 8 is a schematic plan view of turn stopping means provided in one embodiment of a seat in accordance with the present invention, which is in the state where stopping of turn of the seat is released;

FIG. 9 is a schematic diagram of another embodiment of a seat for a vehicle in accordance with the present invention, which is in the front-facing position;

FIG. 10 is a sectional view of turn control means and a locking mechanism in another embodiment of a seat for a vehicle in accordance with the present invention, taken along line X-X in FIG. 9;

FIG. 11 is a schematic diagram of another embodiment of a seat for a vehicle in accordance with the present invention, which is turned toward a door opening; and

FIG. 12 is a sectional view of turn stopping means and a locking mechanism of another embodiment of a seat for a vehicle, taken along line XII-XII in FIG. 11.

### DETAILED DESCRIPTION OF THE PREFERRED EMBODIMENTS

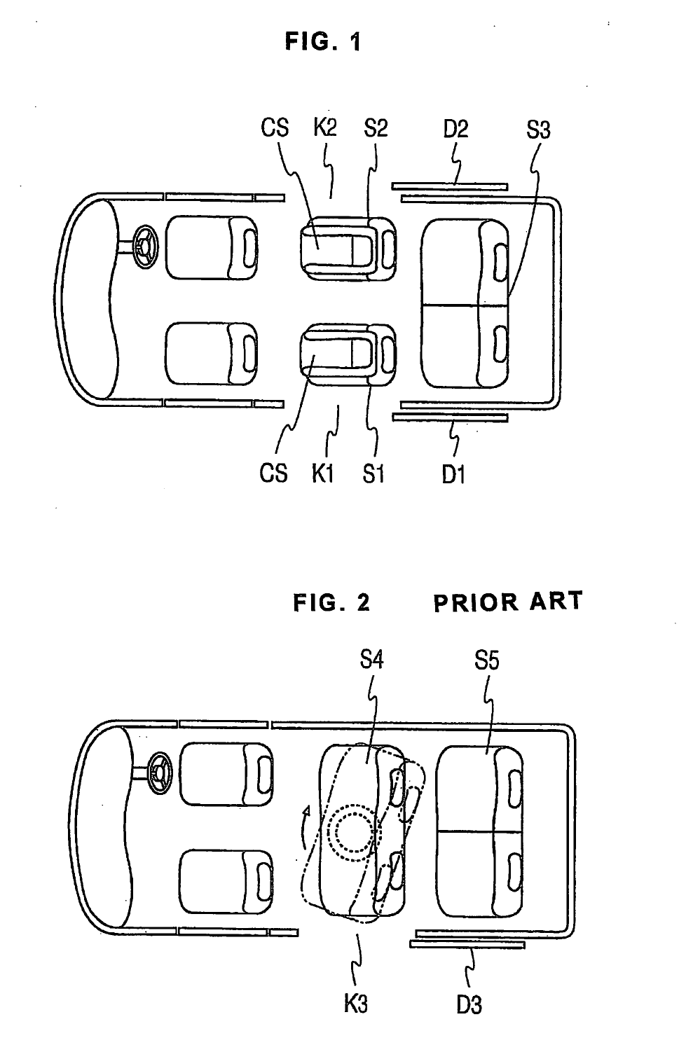

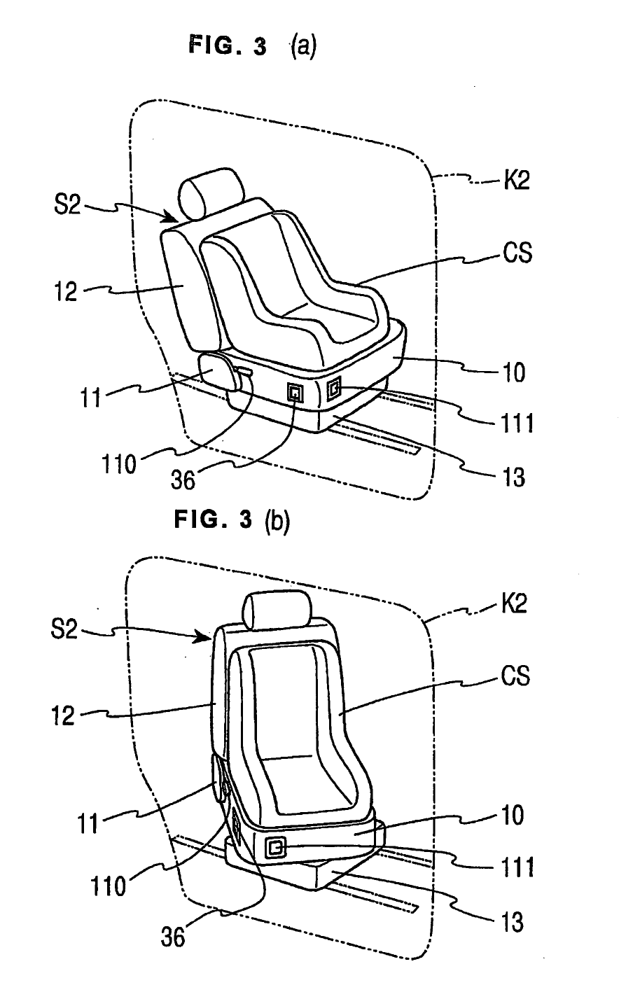

Hereinafter, a first embodiment of a seat for a vehicle will be explained with reference to FIG. 3(a) through FIG. 9. In the present embodiment, the present invention is applied to separate turning seats S1 and S2 (FIG.1) as second row seats which are provided adjacently to left and right door openings of a vehicle. The turning seats S1 and S2 have an identical construction to each other. The following explanations will be based on the right side turning seat S2.

As shown, the turning seat S2 has a seat main body including a seat cushion 10 and a seat back 12 which is assembled onto the seat cushion 10 via a reclining device 11. The seat main body is mounted on a support base 13 via a turning device 2 so as to turn frontward and rearward, and the support base 13 is mounted on a vehicle floor via a sliding mechanism so as to slide frontward and rearward. In FIG. 3(a) and FIG. 3(b), reference character “CS” designates a child seat, “K2” designates a door opening provided in a side surface of a vehicle body, “110” designates a reclining lever of the reclining device 11, and “111” designates a sliding lever of the sliding mechanism.

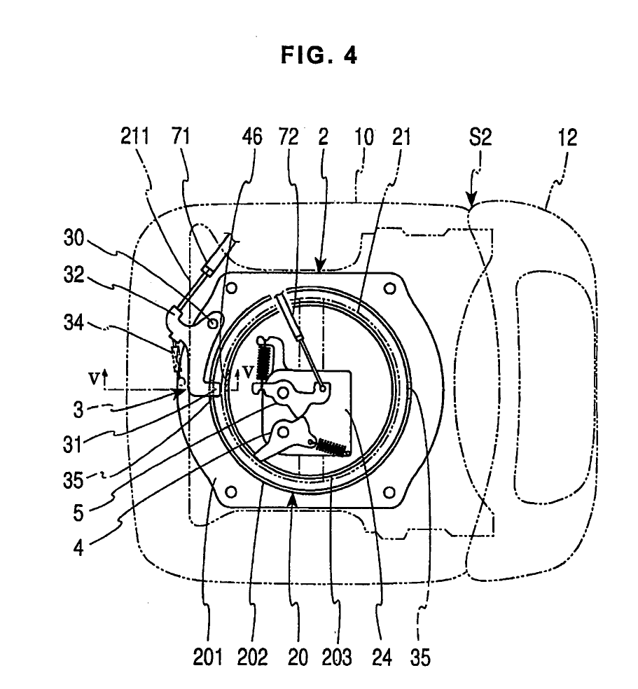

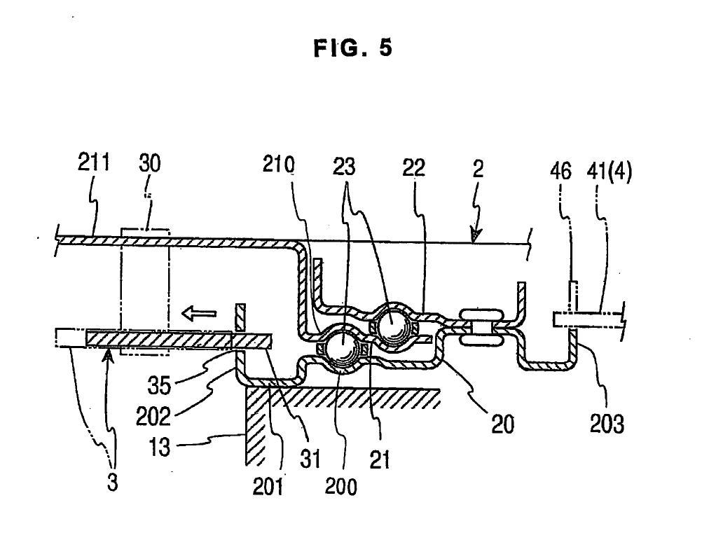

As shown in FIG. 4 and FIG. 5, the turning device 2 includes a lower member 20 having an approximately ring-shaped configuration, an upper member 21 provided above the lower member 20 to turn therealong, and a set plate 22 provided above the upper member 21. An inner peripheral part of the upper member 21 is held by the lower member 20 and the set plate 22 with a plurality of balls interposed therebetween, whereby the upper member 21 is turnably supported by both the lower member 20 and the seat plate 22. The turning range and the turning direction of the upper member 21 are adjusted with a stopper member (not shown). The turning range of the upper member 21 is about 180 degrees which enables the seat main body to turn between the front-facing position and the rear-facing position. The turning direction is the direction toward the door opening K2. The lower member 20 has a ring-shaped main body 200 and an outer peripheral part 201 which protrudes from the ring-shaped main body 200. The upper member 21 has a ring-shaped main body 210 and an outer peripheral part 211 which protrudes from the ring-shaped main body 210. By securing the outer peripheral part 201 of the lower member 20 to an upper surface of the support base 13, and securing the outer peripheral part 211 of the ring-shaped main body 210 of the upper member 21 to a bottom surface of the seat cushion 10, the turning device 2 is mounted between the support base 13 and the seat cushion 10. The seat main body of the seat S2 turns along the support base 13 integrally with the upper member 21.

The turning device 2 further includes a lock lever 3 as a locking mechanism for locking turn of the upper member 21 along the lower member 20 when the seat S2 is turned to the front-facing position or the rear-facing position.

A shaft 30 is provided so as to project downward from a front end of the outer peripheral part 211 of the upper member 21, and the lock lever 3 is turnably supported with a lower end of the shaft 30. An inside end 31 of the lock lever 3 bends into an L-shaped configuration, and projects toward an axial center of the turning device 2. A spring member 34 is mounted between an outside end 32 of the lock lever 3 and a front edge of the outer peripheral part 211 of the upper member 21. The spring member 34 biases the lock lever 3 in such a direction as to lock the turning device 2. When the seat S2 is turned to the front-facing position or the rear-facing position, the lock lever 3 is biased with the biasing force of the spring member 34, and the inside end 31 engages with an engaging slit 35 provided in the outer peripheral wall 202 of the lower member 20 to lock turn of the turning device 2.

One end of a wire 71 as first connecting means is connected to the outside end 32 of the lock lever 3, and the other end of the wire 71 is connected to a lock releasing lever 36 (FIG. 3) provided in a side surface of the seat cushion 10. When the wire 71 is pulled with the lock releasing lever 36, the lock lever 3 turns against the biasing force of the spring member 34 round the shaft 30 in the direction (the direction indicated by the white arrow in FIG. 5) which is opposite to the locking direction. As a result, the inside end 31 of the lock lever 3 comes out of the engaging slit 35, thereby releasing lock of the turning device 2.

As shown in FIG. 4 through 7, a stopper plate 4 and a control plate 5 are provided in an interior space of the ring-shaped main body 210 of the upper member 21 along an upper surface of a base plate 24 which turns with the seat main body. The stopper plate 4 and the control plate 5 serve as the turn stopping means for stopping turn of the seat main body in a predetermined turning position in which the seat main body faces toward the door opening K2.

The stopper plate 4 is turnably supported with a shaft 40 which is provided on the base plate 24. An outside end 41 of the stopper plate 4 protrudes outward over an inner peripheral wall 203 of the ring-shaped main body 200 of the lower member 20. An inside end 42 of the stopper plate 4 protrudes toward the control plate 5. A spring member 44 is mounted between the stopper plate 4 and the base plate 24 to bias the stopper plate 4 to the stopping position in which the outside end 41 protrudes over the inner peripheral wall 203 of the lower member 20.

A stopper projection 46 is provided in the inner peripheral wall 203 of the lower member 20 so as to project upward from the position corresponding to the outside end 41 of the stopper plate 4.

The control plate 5 is turnably supported with a shaft 50 provided on the base plate 24. An inside end 51 of the control plate 5 protrudes toward the stopper plate 4 to face the inside end 42 thereof.

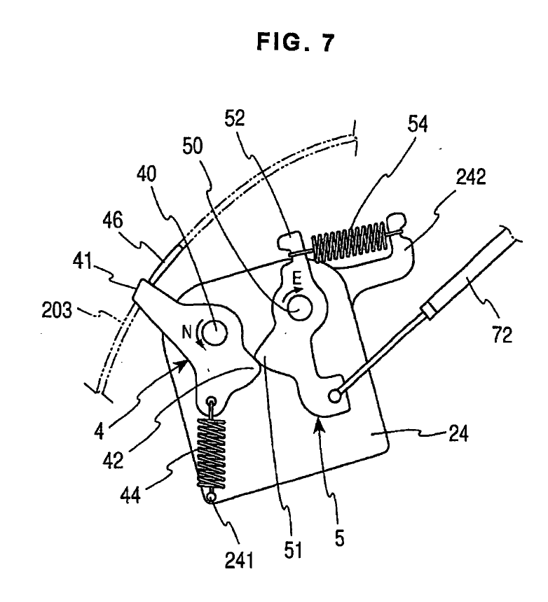

A spring member 54 is mounted between an outside end 52 of the control plate 5 and a protruding part 242 of the base plate 24 to bias the control plate 5 in the direction of the arrow E in FIG. 7. And, normally, the inside end 51 of the control plate 5 contacts the inside end 42 of the stopper plate 4 to stop turn of the stopper plate 4 in the direction of the arrow N in FIG. 7.

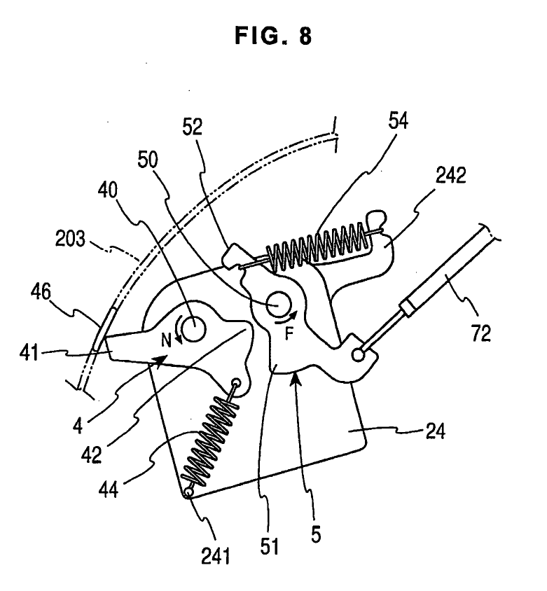

The control plate 5 is connected to a forward tilting mechanism (not shown) of the reclining device 11, which operates when the seat back 12 is tilted forward, via a wire 72 as second connecting means. When the forward tilting mechanism is operated and the wire 72 is pulled, the control plate 5 turns in the direction of the arrow F (FIG. 8) round the shaft 50 against the biasing force of the spring member 54 to release contact between the inside end 42 of the stopper plate 4 and the inside end 51 of the control plate 5.

Hereinafter, the operations of the turning seat S2 will be explained. When the lock releasing lever 36 (FIG. 3(a)) is operated with the seat S2 facing frontward, the wire 71 (FIG. 4) is pulled to turn the lock lever 3 in the lock releasing direction against the biasing force of the spring member 34. And the inside end 31 of the lock lever 3 disengages from the engaging slit 35 to release lock of the seat S2 (as shown by two-dot chain lines in FIG. 5). In this state, when the seat S2 is turned toward the door opening K2, the outside end 41 of the stopper plate 4, which projects over the inner peripheral wall 203 of the lower member 20 contacts the stopper projection 46 provided in the inner peripheral wall 203 to stop turn of the seat S2. The stopper projection 46 is formed in a predetermined turning position of the seat S2, such as the position in which the seat S2 turns by 60 degrees to obliquely face toward the door opening K2.

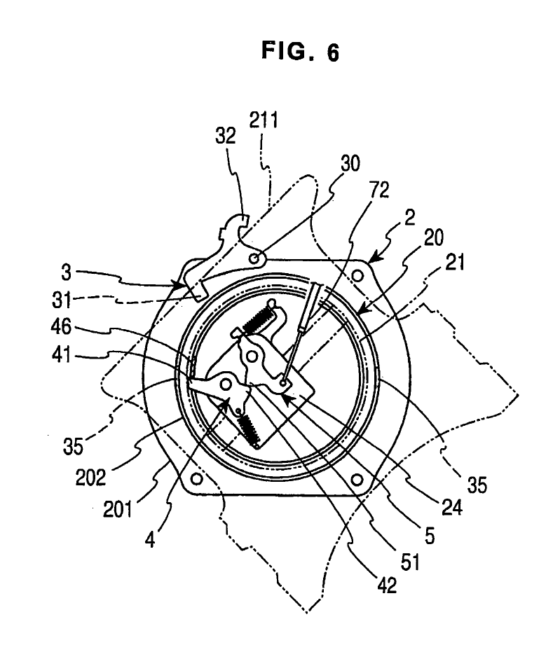

At this time, as shown in FIG. 6 and FIG. 7, the stopper plate 4 is pushed with the stopper projection 46 in the direction of the arrow N, but the inside end 51 of the control plate 5 contacts and pushes the inside end 42 of the stopper plate 4 so that the stopper plate 4 is held in the stopping position. As a result, the seat S2 does not turn further.

When the lock releasing lever 36 is returned with the seat S2 facing toward the door opening K2, the lock lever 3 is returned in the locking direction with the biasing force of the spring member 34, but the inside end 31 of the lock lever 3 contacts the outer peripheral wall 202 of the lower member 20 so as not to achieve the locking operation.

Where the seat S2 is turned from the front-facing position to the rear-facing position, the reclining lever 110 of the reclining device 11 is operated to tilt the seat back 12 forward. When the seat back 12 is tilted forward, as shown in FIG. 8, the wire 72 is pulled to turn the control plate 5 in the direction of the arrow F against the biasing force of the spring member 54. Consequently, the inside end 51 of the control plate 5 disengages from the inside end 42 of the stopper plate 4.

By operating the lock releasing lever 36 in this state, lock of the lock lever 3 is released, and the seat S2 is turned toward the rear-facing position. And when the seat S2 is turned to the predetermined turning position, the stopper plate 4 contacts the stopper projection 46, but the stopper plate 4 can freely turn without being obstructed with the control plate 5, and consequently, the stopper plate 4 turns freely to allow the stopper projection 46 to pass the stopper plate 4. As a result, the seat S2 can turn to the rear-facing position beyond the predetermined turning position. Where the turning seat S2 is turned from the rear-facing position to the front-facing position, the operations similar to the above-described operations are carried out.

With the arrangement of the present embodiment, where the child seat CS is attached to the seat S2 so that the seat back 12 cannot be tilted forward, the seat S2 can be turned by operating the lock releasing lever 36 to release lock of the lock lever 3. In this case, turn of the seat S2 is stopped with the operation of the stopper plate 4 in the predetermined turning position such as the position in which the seat S2 turns by 60 degrees toward the door opening K2. As a result, a child can be readily sat on the child seat CS attached to the seat S2 which faces toward the door opening K2. The predetermined turning position may be arbitrarily determined other than the above-described turning position.

Since the lock releasing lever 36 is provided in a side surface of the seat cushion 10 of the front-facing seat S2, which is on the side of the door opening K2, the lock releasing lever 36 can be readily operated from the exterior of the vehicle body on the side of the door opening K2. The lock releasing lever 36 may be provided in an end of a front surface of the seat cushion 10 on the side of the door opening K2.

When the child seat CS is not attached to the seat S2, the seat back 12 is tilted forward with the reclining device 11 to turn the control plate 5 with the wire 72. As a result, the stopper plate 4 disengages from the control plate 5 to enable the seat S2 to turn frontward or rearward.

Generally, in a conventional wagon-type vehicle, etc., the second row seat is arranged such that lock of turning and sliding thereof is released at a time by tilting the seat back forward. Therefore, when the second-row seat is desired to slide but not desired to turn, there has occurred such an inconvenience that lock of turning is also released to lower the stability of the seat. In contrast, with the present embodiment, lock of turning is released with the lock releasing lever 36 without being released with the forward tilting of the seat back 12, whereby the stability of the seat can be improved during the sliding thereof.

In addition, with the present embodiment, when the child seat CS is not attached to the seat S2, children, aged persons, handicapped persons, etc. can readily get into and out of the vehicle by operating the lock releasing lever 36 to turn the seat S2 to the predetermined turning position which faces toward the door opening K2.

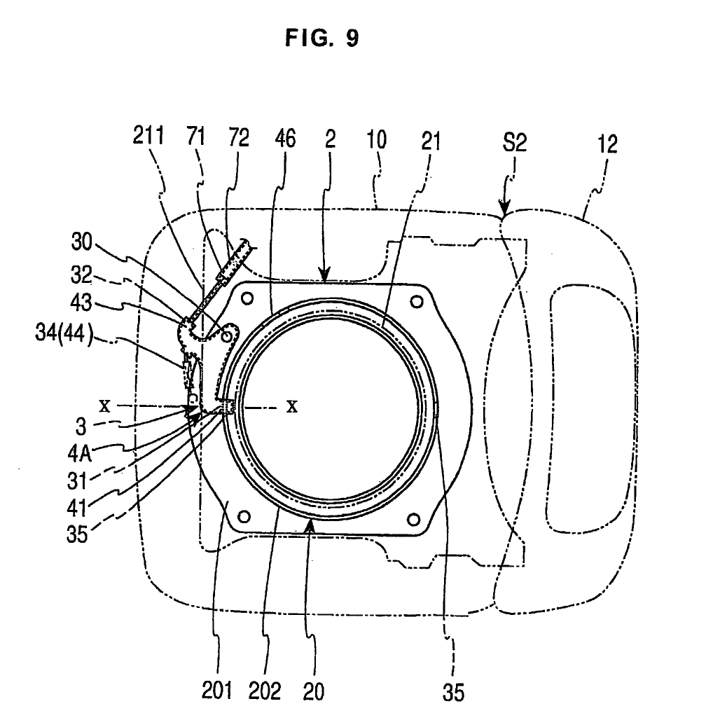

Next, another embodiment of the present invention will be explained with reference to FIG. 9 through FIG. 12. The basic construction of the present embodiment is identical to that of the preceding embodiment. So, different points from the preceding embodiment will be mainly explained. In the drawings, similar members are designated with similar reference numerals and characters, and descriptions thereof will be omitted.

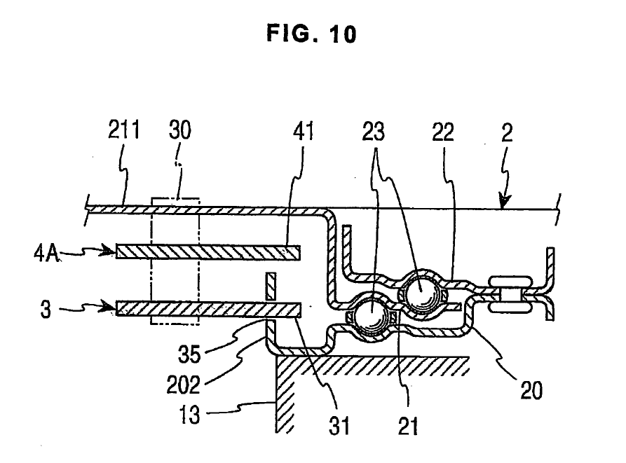

As shown in FIG. 9 and FIG. 10, both a lock lever 3 and a stopper plate 4A are provided at a front end of an outer peripheral part 211 of an upper member 21 of a turning device 2.

The stopper plate 4A has an approximately identical configuration to that of the lock lever 3, and is turnably supported with a shaft 30 over the lock lever 3 in the position slightly higher than the outer peripheral wall 202. A spring member 44 is mounted between an outside end 43 of the stopper plate 4A and a front end of the peripheral part 211 of the upper member 21 to bias the stopper plate 4A in the turn stopping direction. Namely, the stopper plate 4A is turned round the shaft 30 with the spring member 44 so that an inside end 41 of the stopper plate 4A projects inward from an upper edge of the outer peripheral wall 202 of the lower member 20.

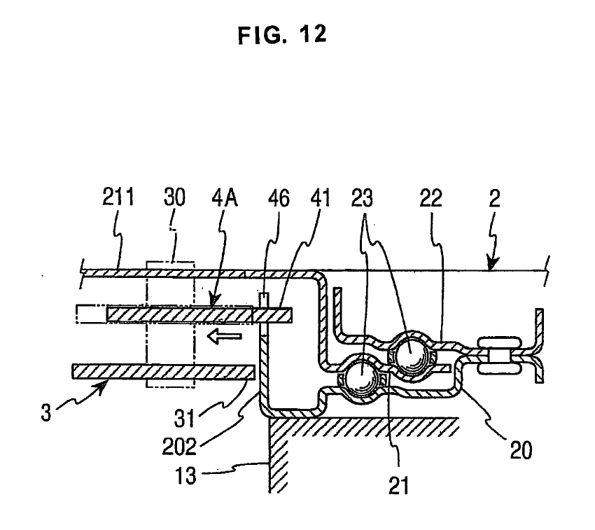

One end of a wire 72 connected to a forward tilting mechanism for a seat back is connected to the outside end 43 of the stopper plate 4A. When the seat back 12 is tilted forward, and the wire 72 is pulled with the operation of the forward tilting mechanism, the stopper plate 4A is turned round the shaft 30 in the stopper releasing direction which is opposite to the stopping direction (in the direction of the white arrow in FIG. 12) against the biasing force of the spring member 44. Consequently, the inside end 41 of the stopper plate 4A moves backward to disengage from the upper edge of the outer peripheral wall 202 of the lower member 20.

A stopper projection 46 is provided in the outer peripheral wall 202 of the lower member 20 in a predetermined position facing the inside end 41 of the stopper plate 4A so as to project upward from the upper edge of the outer peripheral wall 202.

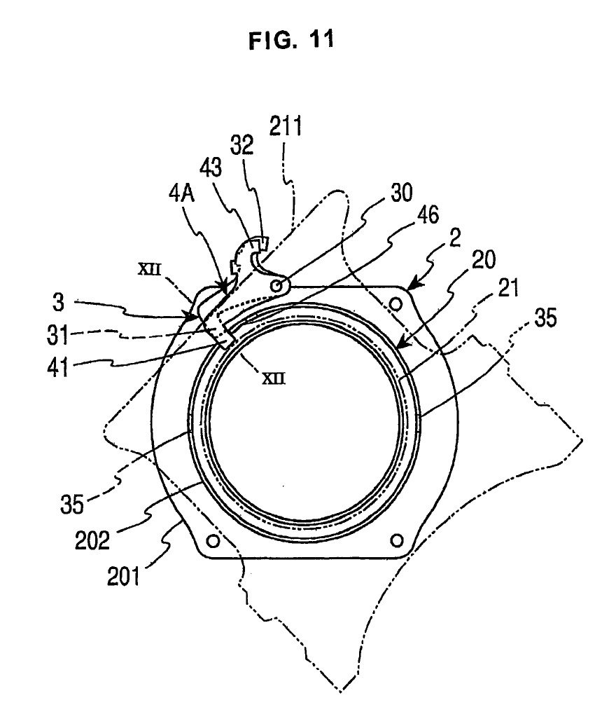

By operating the lock releasing lever 36 (FIG. 3) to release lock of the lock lever 3, the seat S2 is turned, and when the seat S2 is turned to the predetermined turning position which faces toward the door opening K2, the inside end 41 of the stopper plate 4A contacts the stopper projection 46 provided in the lower member 20 to stop further turn of the seat S2 (FIG. 11).

Where the seat S2 is turned from the front-facing position to the rear-facing position, the reclining lever 110 of the reclining device 11 is operated to tilt the seat back 12 forward. By tilting the seat back 12 forward, the wire 72 is pulled to move the stopper plate 4A in the releasing direction against the biasing force of the spring member 44 so that the inside end 41 of the stopper plate 4A moves backward from the outer peripheral wall 202 of the lower member 20 (two-dot chain lines in FIG. 12). And then, the lock releasing lever 36 is operated to release lock of the lock lever 3. Consequently, the seat S2 can be turned to the rear-facing position.

With the present embodiment, operational advantages similar to those of the preceding embodiment can be achieved. In addition, as compared with the preceding embodiment, the number of parts can be decreased, and consequently, the construction of the device can be made simple.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A seat for use in a vehicle, which is provided in a vehicle compartment adjacently to a door opening, comprising:
a seat main body having a seat cushion and a seat back capable of being reclined with a reclining lever of a reclining mechanism, said seat main body being mounted on a turning device so as to turn to a front-facing position and a rear-facing position;
a locking mechanism for locking said seat main body in said front-facing position and said rear-facing position such that lock of said seat main body is released with a lock releasing lever; and
turn stopping means for stopping turn of said seat main body in a predetermined turning position in which said seat main body faces toward said door opening when lock of said seat main body is released by said lock releasing lever with said seat back held upright, and said seat main body is turned toward said door opening, wherein
said turn stopping means has such an arrangement that when said seat back is tilted forward by operating said reclining lever, stopping of turn of said seat main body is released to enable said seat main body to turn to said front-facing position and said rear-facing position.

2. A seat for use in a vehicle, as claimed in claim 1, wherein said predetermined turning position of said seat main body is such a turning position in which said seat main body is directed obliquely frontward so as to face toward said door opening.

3. A seat for use in a vehicle, as claimed in claim 1, wherein said turning device includes:
a lower member provided on a floor of a vehicle compartment; and
an upper member provided to turn along said lower member for mounting said seat main body thereon,
said locking mechanism includes:
an engaging portion which is provided in one of said lower member and said upper member; and
a lock lever which is turnably supported with the other one of said lower member and said upper member in such a manner as to engage with and disengage from said engaging portion, said lock lever being connected to said lock releasing lever via first connecting means so as to be operated with said lock releasing lever, and
said turn stopping means includes:
a stopper projection which is provided in one of said lower member and said upper member of said turning device;
a stopper plate which is provided in the other one of said lower member and said upper member so as to contact said stopper projection when said seat main body turns toward said door opening and reaches said predetermined turning position; and
a control plate which is provided in said the other one of said lower member and said upper member near said stopper plate, and is connected to said reclining mechanism via second connecting means, said turn stopping means being arranged such that when said seat back is held upright, said control plate engages with said stopper plate to hold said stopper plate in contact with said stopper projection, thereby stopping turn of said seat main body, and that when said seat back is tilted forward, said control plate disengages from said stopper plate to make said stopper plate free from said stopper projection, thereby enabling turn of said seat main body to said front-facing position and said rear-facing position.

4. A seat for use in a vehicle, as claimed in claim 1, wherein
said turning device includes:
a lower member provided on a floor of a vehicle compartment; and
an upper member provided to turn along said lower member for mounting said seat main body thereon,
said locking mechanism includes:
an engaging portion which is provided in one of said lower member and said upper member; and
a lock lever which is turnably supported with the other one of said lower member and said upper member in such a manner as to engage with and disengage from said engaging portion, said lock lever being connected to said lock releasing lever via first connecting means so as to be operated with said lock releasing lever, and
said turn stopping means includes:
a stopper projection which is provided in one of said lower member and said upper member of said turning device; and
a stopper plate which is provided in the other one of said lower member and said upper member, a center of said stopper plate being turnably supported with said the other one of said lower member and said upper member, one end of said stopper plate being connected to said reclining mechanism via second connecting means, and said turn stopping means being arranged such that when said seat main body of which said seat back is held upright is turned toward said door opening and reaches said predetermined turning position, the other end of said stopper plate contacts said stopper projection to stop turn of said seat main body, and that when said seat back is tilted forward, said stopper plate moves in such a direction that said the other end separates from said stopper projection, thereby enabling turn of said seat main body to said front-facing position and said rear-facing position.

5. A seat for use in a vehicle, as claimed in claim 1, wherein said lock releasing lever is provided in one of a side surface and a front surface of said seat cushion on the side of said door opening.
